(19) United States
(12) Patent Application Publication
(10) Pub. No.: US 2026/0365429 A1
(43) Pub. Date: Nov. 19, 2026

(54) PROCESSING APPARATUS, STORAGE SYSTEM, PROCESSING METHOD, AND NON-TRANSITORY COMPUTER-READABLE MEDIUM

(71) Applicant: TOYOTA JIDOSHA KABUSHIKI KAISHA, Aichi-ken (JP)

(72) Inventors: Kosuke HAKETA, Tokyo-to (JP); Sae KATAYAMA, Tokyo-to (JP); Yoshiaki TOYAMA, Tokyo-to (JP); Tatsuya TSUBAKIMOTO, Tokyo-to (JP); Huy DO XUAN, Tokyo-to (JP); Zoltan BECK, Tokyo-to (JP); Uori KOIKE, Saitama-shi (JP); Tetsuya IWASAKI, Inzai-sh (JP)

(73) Assignee: TOYOTA JIDOSHA KABUSHIKI KAISHA, Aichi-ken (JP)

(21) Appl. No.: 19/669,996

(22) Filed: May 7, 2026

(30) Foreign Application Priority Data
May 16, 2025 (JP) 2025-082746

(51) Int. Cl. B65G 1/137; G05D 1/667; G05D 105/28; G05D 107/17

(52) U.S. Cl. CPC B65G 1/1371; G05D 1/667; B65G 2203/0216; G05D 2105/285; G05D 2107/17

(57) ABSTRACT

A processing apparatus capable of adjusting the storage spaces of posts assigned to respective individual dwellings. A processing apparatus is a processing apparatus used to convey, by a robot configured to move inside a housing complex, an article between first posts installed in the housing complex and assigned to respective individual dwellings of the housing complex and a second post installed in the housing complex and shared by the individual dwellings of the housing complex, including: an information acquisition unit configured to acquire deposit command information for depositing an article stored in the first post in the second post and retrieval command information for retrieving the article from the second post and storing the retrieved article in the first post ; and a control unit configured to control the robot based on the deposit command information or the retrieval command information.

### CROSS REFERENCE TO RELATED APPLICATIONS

This application is based upon and claims the benefit of priority from Japanese patent application No. 2025-82746, filed on May 16, 2025, the disclosure of which is incorporated herein in its entirety by reference.

### BACKGROUND

The present disclosure relates to a processing apparatus, a storage system, a processing method, and a processing program. For example, the present disclosure relates to a processing apparatus, a storage system, a processing method, and a processing program which are used to convey, by a robot configured to move inside a housing complex, an article between first posts installed in the housing complex and assigned to respective individual dwellings of the housing complex and a second post installed in the housing complex and shared by the individual dwellings of the housing complex.

For example, Patent Literature 1 discloses a delivered-article delivery system in which a delivered article which is addressed to a user and has been stored in a storage part is taken out therefrom and loaded on a delivery apparatus, and the delivery apparatus delivers the delivered article to a delivery place designated by the user.

[Patent Literature 1] Japanese Unexamined Patent Application Publication No. 2024-174272

### SUMMARY

The applicant of the present disclosure has found the following problem. The delivered-article delivery system disclosed in Patent Literature 1 can deliver the delivered article to the delivery place designated by the user, but cannot adjust (i.e., organize) the storage spaces of the posts assigned to the respective individual dwellings.

The present disclosure has been made to solve such a problem, and provides a processing apparatus, a storage system, a processing method, and a processing program capable of adjusting (i.e., organizing) the storage spaces of posts assigned to respective individual dwellings.

A processing apparatus according to an aspect of the present disclosure is a processing apparatus used to convey, by a first robot configured to move inside a housing complex, an article between first posts installed in the housing complex and assigned to respective individual dwellings of the housing complex and a second post installed in the housing complex and shared by the individual dwellings of the housing complex, including:
an information acquisition unit configured to acquire deposit command information for depositing an article stored in the first post in the second post and retrieval command information for retrieving the article from the second post and storing the retrieved article in the first post; and
a control unit configured to control the first robot based on the deposit command information or the retrieval command information.

In the above-described processing apparatus, the control unit preferably controls a second robot configured to move outside the housing complex or notifies a worker so that the article stored in the second post is stored in a third post installed outside the housing complex.

The above-described processing apparatus preferably further includes a selection unit configured to select which of the second post and the third post the article should be deposited in, in which
the information acquisition unit preferably acquires desired time limit information until the article retrieved from the second post or the third post is stored in the first post, and
the selection unit preferably selects which of the second post and the third post the article should be deposited in based on the desired time limit information.

In the above-described processing apparatus, a plurality of third posts are preferably arranged, and
the selection unit preferably selects the third post in such a manner that the longer the desired time limit information is, a third post further from the first post is selected.

In the above-described processing apparatus, the information acquisition unit preferably acquires the retrieval command information of the article or article information including a name of the article, and
the processing apparatus preferably includes:
a determination unit configured to determine a possibility of retrieval of the article based on the retrieval command information of the article or the article information, and
a selection unit configured to select which of the second post and the third post the article should be deposited in based on the possibility of retrieval of the article.

In the above-described processing apparatus, a plurality of third posts are preferably arranged, and the selection unit preferably selects the third post in such a manner that the lower the possibility of retrieval of the article is, a third post further from the first post is selected.

In the above-described processing apparatus, the determination unit preferably periodically determines the possibility of retrieval of the article, and
the selection unit preferably periodically selects the third post in such a manner that the higher the possibility of retrieval of the article is, a third post closer to the first post is selected.

In the above-described processing apparatus, the information acquisition unit preferably acquires the retrieval command information of the article or article information including a name of the article, and
the processing apparatus preferably includes:
a determination unit configured to determine a possibility of retrieval of the article based on the retrieval command information of the article or the article information, and
a notification unit configured to send a retrieval reminder to an owner of the article based on the possibility of retrieval of the article.

In the above-described processing apparatus, the deposit command information preferably includes periodic deposit time information of the article.

In the above-described processing apparatus, the information acquisition unit preferably acquires the deposit command information of the article or article information including a name of the article,
the determination unit preferably determines a possibility of deposit of the article based on the deposit command information of the article or the article information, and
the notification unit preferably sends a deposit reminder to an owner of the article based on the possibility of deposit of the article.

In the above-described processing apparatus, the retrieval command information preferably includes periodic retrieval time information of the article.

A storage system according to an aspect of the present disclosure includes:
the above-described processing apparatus;
first posts installed in the housing complex and assigned to respective individual dwellings of the housing complex;
a second post installed in the housing complex and shared by the individual dwellings of the housing complex; and
a robot configured to move inside the housing complex and convey an article between the first post and the second post.

A processing method according to an aspect of the present disclosure is a processing method used to convey, by a robot configured to move inside a housing complex, an article between first posts installed in the housing complex and assigned to respective individual dwellings of the housing complex and a second post installed in the housing complex and shared by the individual dwellings of the housing complex, in which
a computer performs:
acquiring deposit command information for depositing an article stored in the first post in the second post and retrieval command information for retrieving the article from the second post and storing the retrieved article in the first post; and
controlling the robot based on the deposit command information or the retrieval command information.

A processing program according to an aspect of the present disclosure is a processing program used to convey, by a robot configured to move inside a housing complex, an article between first posts installed in the housing complex and assigned to respective individual dwellings of the housing complex and a second post installed in the housing complex and shared by the individual dwellings of the housing complex, in which the processing program causes a computer to perform:
a process of acquiring deposit command information for depositing an article stored in the first post in the second post and retrieval command information for retrieving the article from the second post and storing the retrieved article in the first post; and
a process of controlling the robot based on the deposit command information or the retrieval command information.

According to the present disclosure, it is possible to provide a processing apparatus, a storage system, a processing method, and a processing program capable of adjusting (i.e., organizing) the storage spaces of posts assigned to respective individual dwellings.

The above and other objects, features and advantages of the present disclosure will become more fully understood from the detailed description given hereinbelow and the accompanying drawings.

### BRIEF DESCRIPTION OF DRAWINGS

FIG. 1 is a block diagram showing a configuration of a control system of a storage system according to a first embodiment;

FIG. 2 shows states when an article is retrieved and deposited in the storage system according to the first embodiment;

FIG. 3 is a perspective view roughly showing a configuration of a robot of the storage system according to the first embodiment;

FIG. 4 is a block diagram showing a configuration of the robot of the storage system according to the first embodiment;

FIG. 5 is a flowchart showing a flow of depositing an article from a first post to a second post by using the storage system according to the first embodiment;

FIG. 6 is a flowchart showing a flow of storing an article deposited in a second post to a first post by using the storage system according to the first embodiment;

FIG. 7 is a block diagram showing a configuration of a control system of a storage system according to a second embodiment;

FIG. 8 shows states when an article is retrieved and deposited in the storage system according to the second embodiment;

FIG. 9 is a perspective view roughly showing a configuration of a second robot of the storage system according to the second embodiment;

FIG. 10 is a block diagram showing a configuration of the robot of the storage system according to the second embodiment;

FIG. 11 is a flowchart showing a flow of depositing an article from a first post to a second post or a third post by using the storage system according to the second embodiment;

FIG. 12 is a flowchart showing a flow of depositing an article from a first post to a second post or a third post by using the storage system according to the second embodiment;

FIG. 13 is a flowchart showing a flow of storing an article deposited in a second post or a third post to a first post by using the storage system according to the second embodiment;

FIG. 14 is a flowchart showing a flow of storing an article deposited in a second post or a third post to a first post by using the storage system according to the second embodiment;

FIG. 15 is a block diagram showing a configuration of a control system of a storage system according to a third embodiment;

FIG. 16 is a block diagram showing a configuration of a control system of a storage system according to a fourth embodiment; and

FIG. 17 shows an example of a hardware configuration.

### DESCRIPTION OF EMBODIMENTS

A specific embodiment to which the present disclosure is applied will be described hereinafter in detail with reference to the drawings. However, the present disclosure is not limited to the below-shown embodiment. Further, the following description and drawings are simplified as appropriate.

### First Embodiment

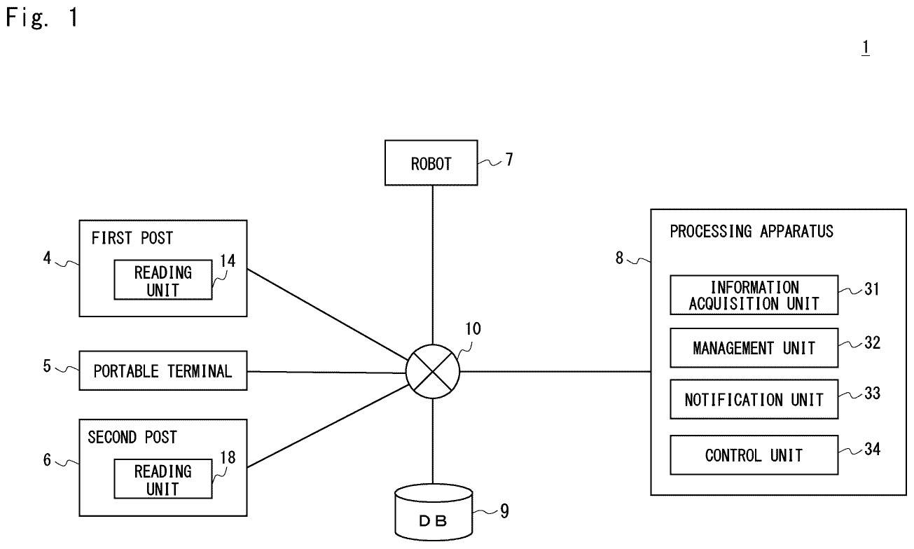

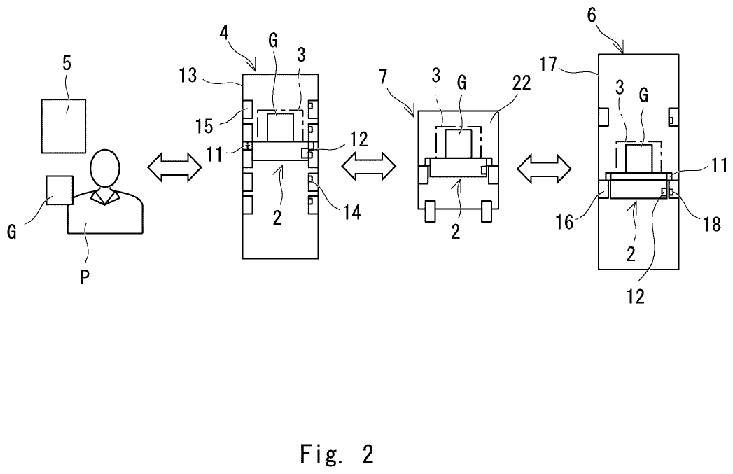

Firstly, a configuration of a storage system according to this embodiment will be described. FIG. 1 is a block diagram showing a configuration of a control system of a storage system according to this embodiment. FIG. 2 shows states when an article is retrieved and deposited in the storage system according to this embodiment.

As shown in FIGS. 1 and 2, the storage system 1 according to this embodiment is, for example, suitable for a situation in which the owner P of an article G stored in a first post 4 deposits (e.g., requests to store in the common poste or the like (second post 6 in this case)) the article G in a second post 6, or he/she retrieves (e.g., requests to take out) an article G stored in the second post 6 and stores it in the first post 4.

As shown in FIGS. 1 and 2, the storage system 1 includes, for example, a tray 2, a storage box 3, a first post 4, a portable terminal 5, a second post 6, a robot 7, a processing apparatus 8, and a database (DB) 9.

The first post 4, the portable terminal 5, the second post 6, the robot 7, the processing apparatus 8, and the DB 9 are connected to each other through a network 10. Note that the network 10 is preferably a wired or wireless communication line, for example, the Internet.

As shown in FIG. 2, the tray 2 has, for example, a plate-like shape as its basic shape on which an article G can be placed, and a brim 11 horizontally protrudes from the side of the tray 2. Further, for each tray 2, a tag 12 in which identification information assigned to that tray 2 is stored is provided on the side surface of the tray 2.

The tag 12 may be, for example, an NFC (Near Field Communication) tag from which the identification information can be read by a reading apparatus. The tray 2 is, for example, repeatedly used for conveying an article G and conveyed together with the article G.

The storage box 3 is, for example, a box that can be opened and closed as shown in FIG. 2, and is used for storing an article G to be conveyed. The storage box 3 is placed on the tray 2. Note that the identification information of the tray 2 may preferably include the identification information of the storage box 3 including information about the height of the storage box 3. Note that it is sufficient if the storage box 3 has a shape in which an article G can be stored, and may be, for example, formed integrally with the tray 2. A box owned by the owner P of an article G may be used as the storage box 3.

A first post 4 is assigned to each of the individual dwellings of the housing complex, and is preferably installed, for example, near the door of the individual dwelling. The first post 4 is used to store an article G which is to be deposited in the second post 6 or to store an article G retrieved from the second post 6. The first post 4 includes, for example, a frame 13 and a reading unit 14 as shown in FIG. 2.

The basic form of the frame 13 is, for example, a roughly rectangular shape when the frame 13 is viewed from the front. Note that, for example, the front of the frame 13 is preferably positioned on the side of the common corridor of the housing complex, and the rear of the frame 13 is positioned on the inside of the individual dwelling. On the inner-side surfaces of the frame 13, for example, a plurality of pairs of rails 15 are arranged at certain intervals in the up/down direction of the frame 13 as shown in FIG. 2.

The pair of rails 15 extends, for example, in the front/rear direction of the frame 13 as shown in FIG. 2, and supports the tray 2 as the brims 11 of the tray 2 are placed in the pair of rails 15. For each of the plurality of pairs of rails 15, identification information including information about the vertical position of the pair of rails 15 is attached to the pair of rails 15.

As shown in FIG. 2, for example, for each of the pairs of rails 15, a reading unit 14 is fixed to the frame 13. The reading unit 14 reads the identification information of the tray 2 from the tag 12 when the tray 2 is supported by (e.g., inserted in) the pair of rails 15.

The identification information of the first post 4 including the positional information of the first post 4 and the identification information of the rails 15 are attached to the reading unit 14. The reading unit 14 associates the read identification information of the tray 2 with the identification information of the first post 4 and the identification information of the rails 15 supporting the tray 2 in the first post 4, and transmits these identification information items to the DB 9.

The portable terminal 5 is, for example, a portable terminal possessed by the owner P of the article G, and is used, for example, for inputting the deposit command information of the article G, the retrieval command information of the article G, the article information, and the storage completion information indicating that the storage of the article G in the storage box 3 is completed, and for acquiring the conveyance completion information indicating that the storage box 3 is stored in the first post 4 from the processing apparatus 8.

The deposit command information of the article G is instruction information for storing the article G stored in the first post 4 in the second post 6. The retrieval command information of the article G is instruction information for retrieving the article G stored in the second post 6 and storing it in the first post 4. The article information preferably includes, for example, information indicating the name of the article G and information indicating the name, the address, and the like of the owner P of the article G.

The second post 6 is installed, for example, near the entrance of the housing complex as a common post for the individual dwellings (i.e., a post shared by the individual dwellings) of the housing complex. The second post 6 is used for storing an article G to be deposited. Note that a storage box 3 in an empty state, placed on the tray 2 is stored in the second post 6 in advance.

The structure of the second post 6 is roughly identical to that of the first post 4, but the second post 6 is preferably larger than the first post 4. Therefore, as shown in FIG. 2, the second post 6 includes, for example, a frame 17 in which a plurality of pairs of rails 16 are arranged, and reading units 18 disposed in the frame 17 so as to be able to read the identification information of a tray 2 supported by the pair of rails 16 from the tag 12 of the tray 2.

Note that the front of the frame 17 may be positioned on the outside of the housing complex, and the rear of the frame 17 may be disposed on the inside the housing complex. Identification information of the second post 6 including positional information of the second post 6 and identification information of the rails 16 are attached to the reading unit 18.

The reading unit 18 associates the read identification information of the tray 2 with the identification information of the second post 6 and the identification information of the rails 16 supporting the tray 2 in the second post 6, and transmits these identification information items to the DB 9.

The robot 7 is a mobile body for conveying an article G from the first post 4 to the second post 6 or conveying an article G from the second post 6 to the first post 4. That is, the robot 7 is disposed so as to be able to move inside the housing complex.

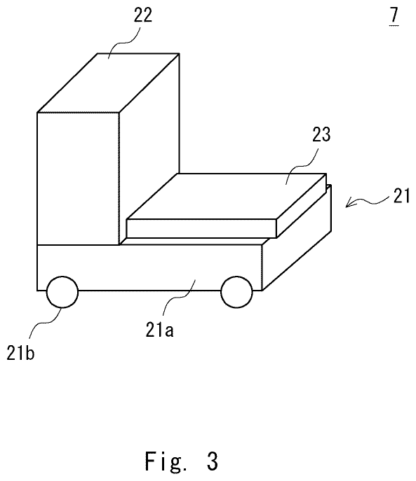

FIG. 3 is a perspective view schematically showing the structure of the robot of the storage system according to this embodiment. As shown in FIG. 3, the robot 7 includes, for example, a carriage part 21, a storage part 22 which is provided on the carriage part 21 and in which a tray 2 on which a storage box 3 is placed can be stored, and a mounting table 23 which is provided on the carriage part 21 and on which a tray 2 on which a storage box 3 is placed can be placed.

The mounting table 23 includes a mechanism for mounting a tray 2 retrieved from the storage part 22 thereon and storing this tray 2 in the first post 4 or the second post 6, or mounting a tray 2 retrieved from the first post 4 or the second post 6 thereon and storing this tray 2 in the storage part 22.

The mounting table 23 can be moved up and down along the vertical direction and includes an extendable arm (not shown) that can be expanded and contracted along the horizontal direction axis. The mounting table 23 may be configured to be rotatable about the vertical axis. Further, the mounting table 23 may be configured to be movable in all directions (360°) with a tray 2 placed thereon.

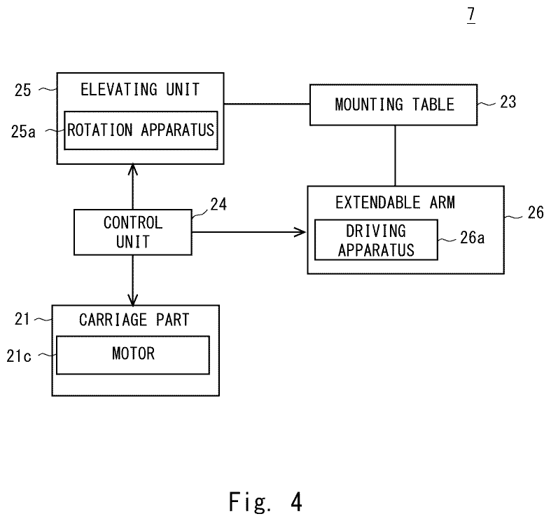

FIG. 4 is a block diagram showing the configuration of the robot of the storage system according to this embodiment. The robot 7 includes a control unit 24. The control unit 24 is preferably provided in the robot 7. The control unit 24 controls the carriage part 21, an elevating unit 25, and the extendable arm 26 based on control information received from the control unit 34 of the processing apparatus 8.

As shown in FIGS. 3 and 4, the carriage part 21 includes a base part 21a, wheels 21b rotatably provided on the base part 21a, and motors 21c for rotationally driving predetermined wheels 21b. Each motor 21c rotates a predetermined wheel 21b based on a control signal received from the control unit 24. In this way, the robot 7 can move to and stop at an arbitrary position.

Note that the configuration of the carriage part 21 is merely an example and is not limited to the above example. For example, the number of wheels 21b of the carriage part 21 can be arbitrarily determined, and any configuration can be applied as long as the robot 7 can move to an arbitrary position.

The elevating unit 25 includes a rotation apparatus 25a, and expands or contracts along the vertical axis by the driving of the rotation apparatus 25a, and thereby moving up or down the mounting table 23. As the mounting table 23 is moved up or down, it is possible to hand over the tray 2 to or from a space at a different height of the first post 4 or the second post 6.

The extendable arm 26 is attached to the mounting table 23. The extendable arm 26 includes an arm main part (not shown) and a driving apparatus 26a. The driving apparatus 26a is attached inside the mounting table 23 and moves the arm main part in the horizontal direction. The driving apparatus 26a may further include a mechanism for rotating the arm main part about the axis.

After the elevating unit 25 moves up or down the mounting table 23 to the height of the empty space of the first post 4 or the second post 6, the extendable arm 26 slides the tray 2 along the rails 15 of the first post 4 or the rails 16 of the second post 6. In this way, the robot 7 can store the tray 2 on which the storage box 3 is placed in the empty space of the first post 4 or the second post 6.

After the elevating unit 25 moves up or down the mounting table 23 to the height of the storage space of the first post 4 or the second post 6, the extendable arm 26 slides and retrieves (i.e., takes out) the tray 2 from the storage space along the rails 15 of the first post 4 or the rails 16 of the second post 6. In this way, the robot 7 can retrieve (i.e., takes out) the tray 2 on which the storage box 3 is placed from the storage space of the first post 4 or the second post 6.

For example, as shown in FIG. 1, the processing apparatus 8 includes an information acquisition unit 31, a management unit 32, a notification unit 33, and a control unit 34. The information acquisition unit 31 acquires the identification information of the first post 4 with which the identification information of the tray 2 is associated and the identification information of the rails 15 supporting the tray 2 in the first post 4.

Further, the information acquisition unit 31 acquires the identification information of the second post 6 with which the identification information of the tray 2 is associated, the identification information of the rails 16 supporting the tray 2 in the second post 6, information indicating the usage state of the first post 4, information indicating the usage state of the second post 6, deposit command information, retrieval command information, article information, storage completion information, and conveyance completion information.

The management unit 32 associates the article information with the identification information of the tray 2 based on the article information and the identification information of the tray 2. Further, the management unit 32 manages the usage state of the first post 4 based on the identification information of the first post 4 with which the identification information of the tray 2 is associated and the identification information of the rails 15 supporting the tray 2 in the first post 4, and generates information indicating the usage state of the first post 4.

Further, the management unit 32 manages the usage state of the second post 6 based on the identification information of the second post 6 with which the identification information of the tray 2 is associated and the identification information of the rails 16 supporting the tray 2 in the second post 6, and generates information indicating the usage state of the second post 6.

Therefore, the information indicating the usage state of the first post 4 and the information indicating the usage state of the second post 6 preferably include, for each post, identification information of used rails and vacant rails in the post, information indicating whether or not the storage box 3 supported by the rails through the tray 2 is in a vacant state, information about an article stored in the storage box 3, and the like.

The information indicating the usage state of the first post 4 and the information indicating the usage state of the second post 6 are updated every time the tray 2 is inserted to or pulled out from the post. It should be noted that the management unit 32 preferably recognizes that the storage box 3 is in a vacant state when the owner P retrieves the article G from the storage box 3 and inputs retrieval completion information through the portable terminal 5. Then, the vacant storage box 3 may be conveyed from the first post 4 to the second post 6 by the robot 7.

The notification unit 33 notifies the portable terminal 5 that the storage box 3 has been stored in the first post 4 based on the identification information of the tray 2 and the information indicating the usage state of the first post 4. The control unit 34 controls the robot 7 based on the deposit command information, the retrieval command information, the information indicating the usage state of the first post 4, the information indicating the usage state of the second post 6, and the identification information of the tray 2 with which the article information is associated.

The DB 9 stores therein the identification information of the first post 4 with which the identification information of the tray 2 is associated, the identification information of the rails 15 supporting the tray 2 in the first post 4, the identification information of the second post 6 with which the identification information of the tray 2 is associated, the identification information of the rails 16 supporting the tray 2 in the second post 6, the information indicating the usage state of the first post 4, the information indicating the usage state of the second post 6, the deposit command information, the retrieval command information, the article information, the storage completion information, the conveyance completion information, and the like.

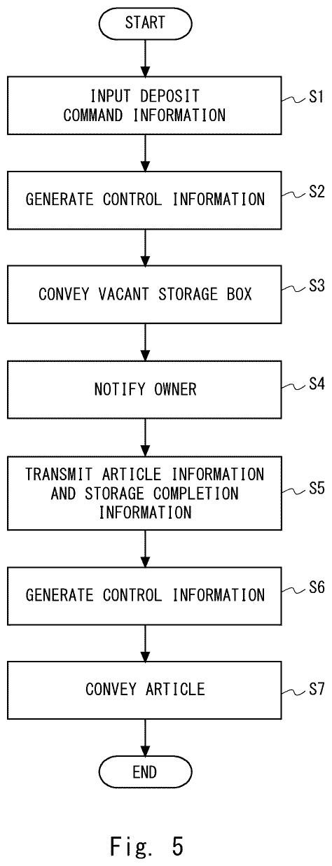

Next, a flow of depositing an article G from the first post 4 in the second post 6 by using the storage system 1 according to this embodiment will be described. FIG. 5 is a flowchart showing a flow of depositing an article from the first post in the second post by using the storage system according to this embodiment.

Firstly, the owner P of an article G who wants to deposit the article G inputs deposit command information through the portable terminal 5 (S1). The portable terminal 5 transmits the deposit command information to the processing apparatus 8. The control unit 34 of the processing apparatus 8 selects a storage box 3 in a vacant state based on the information indicating the usage state of the second post 6, and acquires the identification information of the rails 16 supporting the tray 2 on which the selected storage box 3 is placed and the identification information of the second post 6.

Further, the control unit 34 of the processing apparatus 8 selects rails 15 in which the selected storage box 3 can be stored in the first post 4 based on the information indicating the usage state of the first post 4 and the identification information of the tray 2 on which the selected storage box 3 is placed, and acquires the identification information of the selected rails 15 and the identification information of the first post 4.

Then, the control unit 34 of the processing apparatus 8 generates control information for conveying the selected storage box 3 from the second post 6 to the first post 4 based on the identification information of the rails 16 supporting the tray 2 on which the selected storage box 3 is placed in the second post 6 and the identification information of the second post 6, the identification information of the selected rails 15 in the first post 4, and the identification information of the first post 4 (S2).

Based on the control information, the robot 7 pulls out the tray 2 from the rails 16 supporting the tray 2 on which the selected storage box 3 is placed in the second post 6 and stores the tray 2 in the storage part 22. The management unit 32 of the processing apparatus 8 updates the information indicating the usage state of the second post 6.

Then, based on the control information, the robot 7 conveys the tray 2 on which the selected storage box 3 is placed to the first post 4, retrieves the tray 2 from the storage part 22, inserts the tray 2 in the selected rails 15 in the first post 4, and thereby makes the rails 15 support the tray 2 (S3).

Next, when the management unit 32 of the processing apparatus 8 updates the information indicating the usage state of the first post 4, the notification unit 33 notifies the portable terminal 5 of the conveyance completion information (S4). As a result, the owner P can recognize that the storage box 3 has been stored in the first post 4 through the portable terminal 5.

When the owner P stores an article G he/she wants to deposit in the second post 6 in the storage box 3 and places the storage box 3 on the tray 2, and then the owner P inputs the article information of the article G and the storage completion information thereof through the portable terminal 5, the portable terminal 5 transmits the article information and the storage completion information to the processing apparatus 8 (S5).

Next, the management unit 32 of the processing apparatus 8 associates the article information with the identification information of the tray 2 based on the storage completion information, the article information, and the identification information of the tray 2. At the same time, the management unit 32 updates the information indicating the usage state of the first post 4.

Next, the control unit 34 of the processing apparatus 8 specifies the rails 15 supporting the tray 2 on which the storage box 3 is placed based on the information indicating the usage state of the first post 4 and the identification information of the tray 2 on which the storage box 3 is placed, and acquires the identification information of the specified rails 15 and the identification information of the first post 4.

Then, the control unit 34 of the processing apparatus 8 selects rails 16 in which the storage box 3 can be stored in the second post 6 based on the information indicating the usage state of the second post 6 and the identification information of the tray 2 on which the storage box 3 is placed, and acquires the identification information of the selected rails 16 and the identification information of the second post 6.

The control unit 34 of the processing apparatus 8 generates control information for conveying the storage box 3 from the first post 4 to the second post 6 based on the identification information of the rails 15 supporting the tray 2 on which the storage box 3 is placed in the first post 4, the identification information of the first post 4, the identification information of the selected rails 16 in the second post 6, and the identification information of the second post 6 (S6).

The robot 7 pulls out the tray 2 from the rails 15 supporting the tray 2 on which the storage box 3 is placed in the first post 4, and stores the tray 2 in the storage part 22 based on the control information. The management unit 32 of the processing apparatus 8 updates the information indicating the usage state of the first post 4.

Then, based on the control information, the robot 7 conveys the tray 2 on which the storage box 3 is placed to the second post 6, retrieves the tray 2 from the storage part 22, and inserts the tray 2 in the selected rails 16 in the second post 6, and thereby makes the rails 16 support the tray 2 (S7). The management unit 32 of the processing apparatus 8 updates the information indicating the usage state of the second post 6. In this way, the article G can be deposited from the first post 4 in the second post 6.

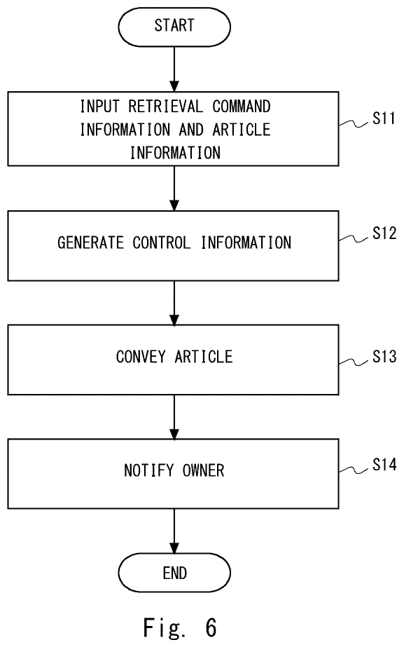

Next, a flow of storing an article G deposited in the second post 6 in the first post 4 by using the storage system 1 according to this embodiment will be described. FIG. 6 is a flowchart showing a flow of storing an article deposited in the second post in the first post by using the storage system according to this embodiment.

Firstly, the owner P of an article G who wants to retrieve the article G from the second post 6 inputs retrieval command information and the article information of the article G through the portable terminal 5 (S11). The portable terminal 5 transmits the retrieval command information and the article information to the processing apparatus 8.

The control unit 34 of the processing apparatus 8 specifies the storage box 3 in which the article G that the owner P wants to retrieve is stored based on the retrieval command information, the article information, and the information indicating the usage state of the second post 6, and acquires the identification information of the rails 16 supporting the tray 2 on which the specified storage box 3 is placed and the identification information of the second post 6.

Further, the control unit 34 of the processing apparatus 8 selects rails 15 in which the specified storage box 3 can be stored in the first post 4 based on the information indicating the usage state of the first post 4 and the identification information of the tray 2 on which the specified storage box 3 is placed, and acquires the identification information of the selected rails 15 and the identification information of the first post 4.

Then, the control unit 34 of the processing apparatus 8 generates control information for conveying the specified storage box 3 from the second post 6 to the first post 4 based on the identification information of the rails 16 supporting the tray 2 on which the specified storage box 3 is placed in the second post 6, the identification information of the second post 6, the identification information of the selected rails 15 in the first post 4, and the identification information of the first post 4 (S12).

Based on the control information, the robot 7 pulls out the tray 2 from the rails 16 supporting the tray 2 on which the specified storage box 3 is placed in the second post 6, and stores the tray 2 in the storage part 22. The management unit 32 of the processing apparatus 8 updates the information indicating the usage state of the second post 6.

Then, based on the control information, the robot 7 conveys the tray 2 on which the specified storage box 3 is placed to the first post 4, retrieves the tray 2 from the storage part 22, inserts the tray 2 in the selected rails 15 in the first post 4, and thereby makes the rails 15 support the tray 2 (S13). In this way, the article G deposited in the second post 6 can be stored in the first post 4.

Next, when the management unit 32 of the processing apparatus 8 updates the information indicating the usage state of the first post 4, the notification unit 33 notifies the portable terminal 5 of the conveyance completion information (S14). As a result, the owner P can recognize that the article G he/she deposited through the portable terminal 5 has been stored in the first post 4.

As described above, the storage system 1 and the processing apparatus 8 according to this embodiment deposit an article G stored in the first post 4 in the second post 6 by using the robot 7, or store an article G deposited in the second post 6 in the first post 4 by using the robot 7. Therefore, the storage space of the first post 4 can be easily adjusted (i.e., organized).

In addition, since an article G is conveyed by the robot 7, the article G can be conveyed at any time. Further, an article G can be stored in a space where a human being cannot reach in the second post 6 and can be retrieved from such a space. Further, compared with the case where a human being conveys an article G, the privacy related to the article G can be secured.

### Second Embodiment

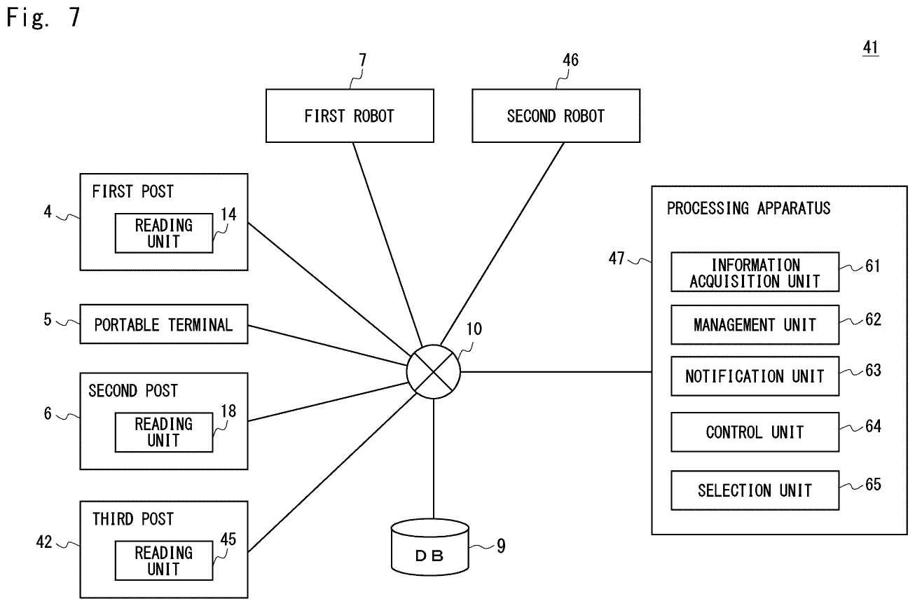

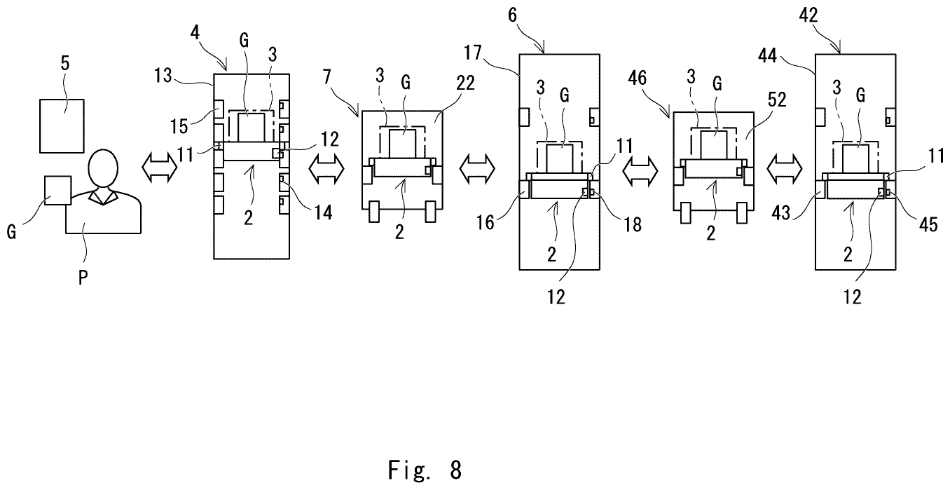

FIG. 7 is a block diagram showing a configuration of a control system of a storage system according to this embodiment. FIG. 8 shows states when an article is retrieved and deposited in the storage system according to this embodiment. The storage system 41 according to this embodiment has a configuration roughly identical to that of the storage system 1 according to the first embodiment, and therefore, its detailed description is omitted. In this embodiment, an article G is stored in the second post 6 or a third post 42 based on desired time limit information of the article G.

The desired time limit information of the article G is input by the owner P of the article G through the portable terminal 5. The desired time limit information of the article G is information indicating a time limit from when the owner P of the article G inputs retrieval command information of the article G to when the article G arrives at the first post 4. The desired time limit information is, for example, within 30 minutes or within two hours, and preferably can be selected through the portable terminal 5.

Regarding the third post 42, for example, a plurality of third posts 42 are preferably arranged over a wide area outside the housing complex in such a manner that the distances from the housing complex to the third posts 42 are different from one another. For example, as shown in FIGS. 7 and 8, the structure of the third post 42 is roughly identical to that of the second post 6. That is, the third post 42 includes a frame 44 in which a plurality of pairs of rails 43 are arranged, and reading units 45 disposed in the frame 44 so as to be able to read the identification information of a tray 2 supported by the pair of rails 43 from the tag 12 of the tray 2.

Identification information of the third post 42 including positional information of the third post 42 and identification information of the rails 43 are attached to the reading unit 45. The reading unit 45 associates the read identification information of the tray 2 with the identification information of the third post 42 and the identification information of the rails 43 supporting the tray 2 in the third post 42, and transmits these identification information items to the DB 9.

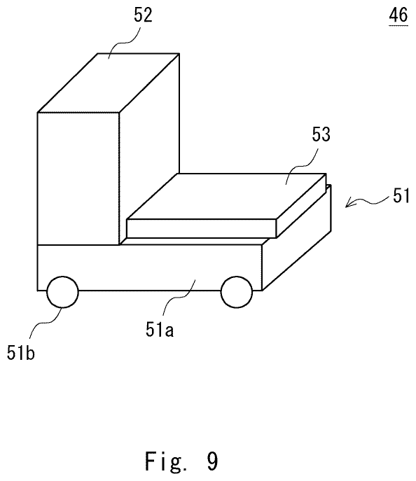

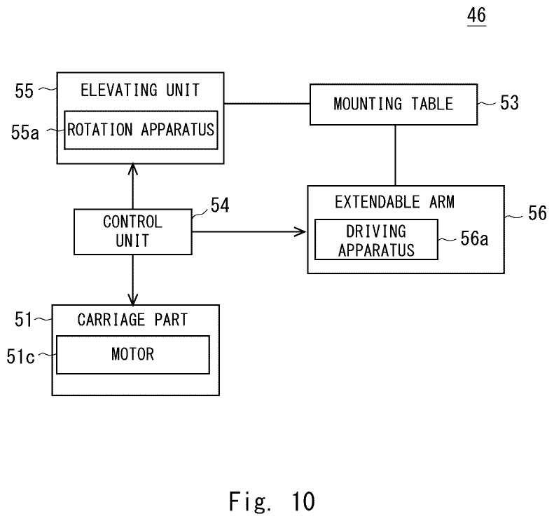

Note that, for example, an article G is preferably conveyed between the second post 6 and the third post 42 by using a second robot 46 outside the housing complex. The second robot 46 preferably has, for example, a configuration roughly identical to that of the robot (first robot) 7 in the first embodiment. FIG. 9 is a perspective view schematically showing the configuration of the second robot of the storage system according to this embodiment. FIG. 10 is a block diagram showing the configuration of the robot of the storage system according to this embodiment.

That is, as shown in FIGS. 9 and 10, the second robot 46 includes a base part 51a, wheels 51b, and a carriage part 51 including a motor(s) 51c, a storage part 52, a mounting table 53, and a control unit 54. Further, the mounting table 53 includes an elevating unit 55 including a rotation apparatus 55a, and an extendable arm 56 including an arm main part and a driving apparatus 56a.

As shown in FIG. 7, a processing apparatus 47 has a configuration roughly identical to that of the processing apparatus 8 in the first embodiment, and includes, in addition to an information acquisition unit 61, a management unit 62, a notification unit 63, and a control unit 64, a selection unit 65. The selection unit 65 selects which of the second post 6 and the third post 42 the article G should be stored in based on the desired time limit information of the article G.

The selection unit 65 determines, for example, whether or not the article G can be retrieved from the third post 42 and stored in the first post 4 through the second post 6 within the desired time limit of the article G based on the desired time limit information of the article G, the moving speed information of the first robot 7, the moving speed information of the second robot 46, the identification information of the first post 4, the identification information of the second post 6, and the identification information of the third post 42. Then, when it is possible, the selection unit 65 selects the third post 42 as the deposit post of the article G, whereas when it is impossible, the selection unit 65 selects the second post 6 as the deposit post of the article G.

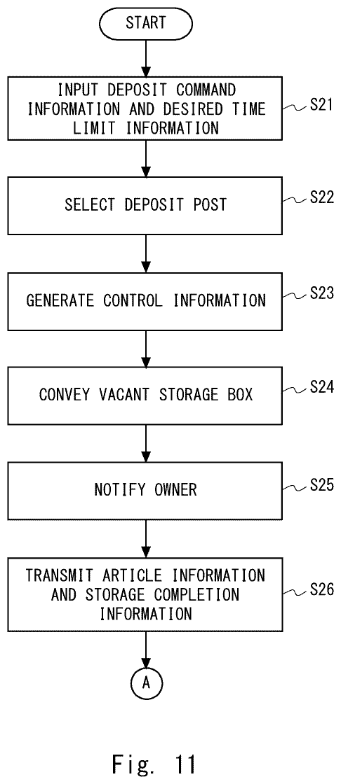

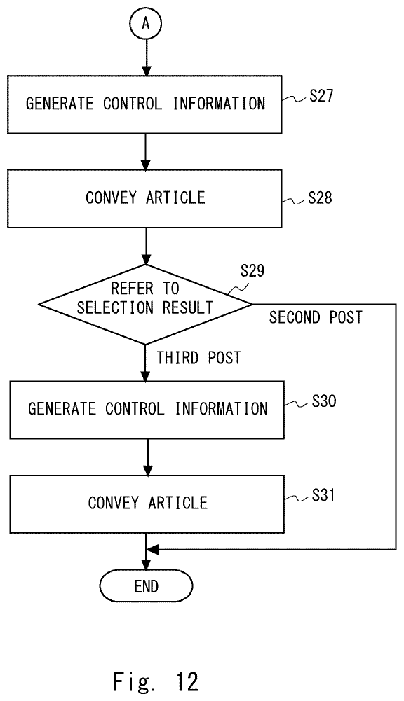

Next, a flow of depositing an article G from the first post 4 to the second post 6 or the third post 42 by using the storage system 41 according to this embodiment will be described. FIGS. 11 and 12 show a flowchart showing a flow of depositing an article G from the first post in the second post or the third post by using the storage system according to this embodiment.

Firstly, the owner P of an article G who wants to deposit the article G inputs deposit command information and desired time limit information of the article G through the portable terminal 5 (S21). The portable terminal 5 transmits the deposit command information and the desired time limit information of the article G to the processing apparatus 47.

The selection unit 65 of the processing apparatus 47 determines whether or not the article G can be retrieved from the third post 42 and stored in the first post 4 through the second post 6 within the desired time limit of the article G based on the desired time limit information of the article G, the moving speed information of the first robot 7, the moving speed information of the second robot 46, the identification information of the first post 4, the identification information of the second post 6, and the identification information of the third post 42.

When it is possible, the selection unit 65 of the processing apparatus 47 selects the third post 42 as the deposit post of the article G. In this process, in the case where there are a plurality of third posts 42, the selection unit 65 preferably selects, among the third posts 42 from which the article G can be retrieved and stored in the first post 4 through the second post 6 within the desired time limit of the article G, a third post 42 farthest from the first post 4. In other words, the selection unit 65 preferably selects the third post 42 in such a manner that the longer the desired time limit of the article G is, a third post 42 further from the first post 4 is selected.

When it is impossible, the selection unit 65 of the processing apparatus 47 selects the second post 6 as the deposit post of the article G (S22). Note that when the article G cannot be stored in the first post 4 within the desired time limit of the article G even when the second post 6 is selected as the deposit post, the processing apparatus 47 preferably requests the owner P of the article G to re-enter the desired time limit information of the article G.

Next, in either case, i.e., in both of when the second post 6 is selected as the deposit post and when the third post 42 is selected as the deposit post, the processing apparatus 47 performs steps S23 to S28 equivalent to the steps S2 to S7 in the flow of depositing the article G from the first post 4 in the second post 6 by using the storage system 1 according to the first embodiment.

Next, the control unit 64 of the processing apparatus 47 refers to the result of the selection by the selection unit 65 (S29). Then, when the second post 6 is selected as the deposit post, the control unit 64 finishes the series of processes. In this way, the article G can be deposited from the first post 4 in the second post 6.

On the other hand, when the third post 42 is selected as the deposit post, the control unit 64 of the processing apparatus 47 specifies, based on the information indicating the usage state of the second post 6 and the identification information of the tray 2 on which the storage box 3 in which the article G that the owner P wants to deposit is stored is placed, the rails 16 supporting the tray 2 on which the storage box 3 is placed, and acquires the identification information of the specified rails 16 and the identification information of the second post 6.

Then, the control unit 64 of the processing apparatus 47 selects rails 43 in which the storage box 3 can be stored in the third post 42 based on the information indicating the usage state of the third post 42 and the identification information of the tray 2 on which the storage box 3 in which the article G that the owner P wants to deposit is stored is placed, and acquires the identification information of the selected rails 43 and the identification information of the third post 42.

The control unit 64 of the processing apparatus 47 generates control information for conveying the storage box 3 from the second post 6 to the third post 42 based on the identification information of the specified rails 16 in the second post 6, the identification information of the second post 6, and the identification information of the selected rails 43 in the third post 42, and the identification information of the third post 42 (S30).

Based on the control information, the second robot 46 pulls out the tray 2 from the specified rails 16 in the second post 6 and stores the tray 2 in the storage part 52. The management unit 62 of the processing apparatus 47 updates the information indicating the usage state of the second post 6.

Then, based on the control information, the second robot 46 conveys the tray 2 on which the storage box 3 is placed to the third post 42, retrieves the tray 2 from the storage part 52, inserts the tray 2 in the selected rails 43 in the third post 42, and thereby makes the rails 43 support the tray 2 (S31). The management unit 62 of the processing apparatus 47 updates the information indicating the usage state of the third post 42. In this way, the article G can be deposited from the first post 4 in the third post 42.

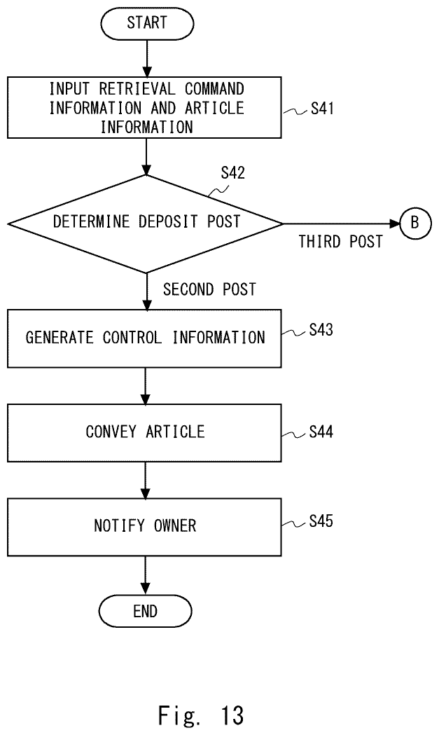

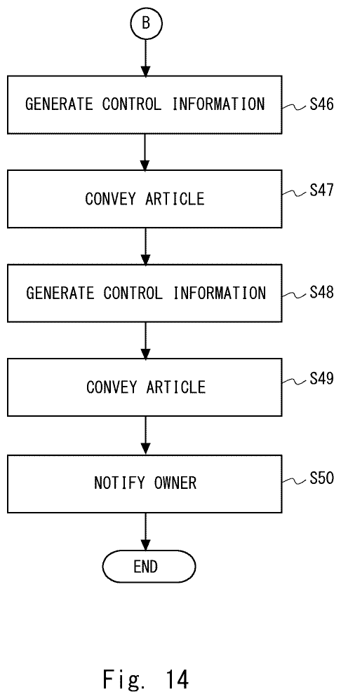

Next, a flow of storing an article G deposited in the second post 6 or the third post 42 in the first post 4 by using the storage system 41 according to this embodiment will be described. FIGS. 13 and 14 show a flowchart showing a flow of storing an article deposited in the second post or the third post in the first post by using the storage system according to this embodiment.

Firstly, the owner P of an article G who wants to retrieve the article G from the second post 6 or the third post 42 inputs retrieval command information and the article information of the article G through the portable terminal 5 (S41). The portable terminal 5 transmits the retrieval command information and the article information to the processing apparatus 47.

The control unit 64 of the processing apparatus 47 specifies the storage box 3 in which the article G that the owner P wants to retrieve is stored based on the retrieval command information, the article information, the information indicating the usage state of the second post 6, and the information indicating the usage state of the third post 42, and determines whether the deposit post of the specified storage box 3 is the second post 6 or the third post 42 (S42).

When the deposit post is the second post 6, the processing apparatus 47 performs steps S43 to S45 equivalent to the steps S12 to S14 in the flow of storing the article G deposited in the second post 6 in the first post 4 by using the storage system 1 according to the first embodiment.

On the other hand, when the deposit post is the third post 42, the control unit 64 of the processing apparatus 47 acquires the identification information of the rails 43 supporting the specified storage box 3 in the third post 42 and the identification information of the third post 42 based on the article information and the information indicating the usage state of the third post 42.

Further, the control unit 64 of the processing apparatus 47 selects rails 16 in which the specified storage box 3 can be stored in the second post 6 based on the information indicating the usage state of the second post 6 and the identification information of the tray 2 on which the specified storage box 3 is placed, and acquires the identification information of the selected rails 16 and the identification information of the second post 6.

Then, the control unit 64 of the processing apparatus 47 generates control information for conveying the specified storage box 3 from the third post 42 to the second post 6 based on the identification information of the rails 43 supporting the tray 2 on which the specified storage box 3 is placed in the third post 42, the identification information of the third post 42, the identification information of the selected rails 16 in the second post 6, and the identification information of the second post 6 (S46).

Based on the control information, the second robot 46 pulls out the tray 2 from the rails 43 supporting the tray 2 on which the specified storage box 3 is placed in the third post 42, and stores the tray 2 in the storage part 52. The management unit 62 of the processing apparatus 47 updates the information indicating the usage state of the third post 42.

Then, based on the control information, the second robot 46 conveys the tray 2 on which the storage box 3 is placed to the second post 6, retrieves the tray 2 from the storage part 52, inserts the tray 2 in the selected rails 16 in the second post 6, and thereby makes the rails 16 support the tray 2 (S47). The management unit 62 of the processing apparatus 47 updates the information indicating the usage state of the second post 6.

After that, the processing apparatus 47 performs steps S48 to S50 equivalent to the steps S12 to S14 in the flow of storing the article G deposited in the second post 6 in the first post 4 by using the storage system 1 according to the first embodiment. In this way, the article G deposited in the second post 6 or the third post 42 can be stored in the first post 4.

As described above, for example, based on the desired time limit information of the article G set by the owner P, when the desired time limit is long, the storage system 41 and the processing apparatus 47 according to this embodiment can deposit the article G in the third post 42 which is installed at a place far from the housing complex and of which the land price is low. In this way, the storage space of the first post 4 can be adjusted (i.e., organized) at a low cost.

### Third Embodiment

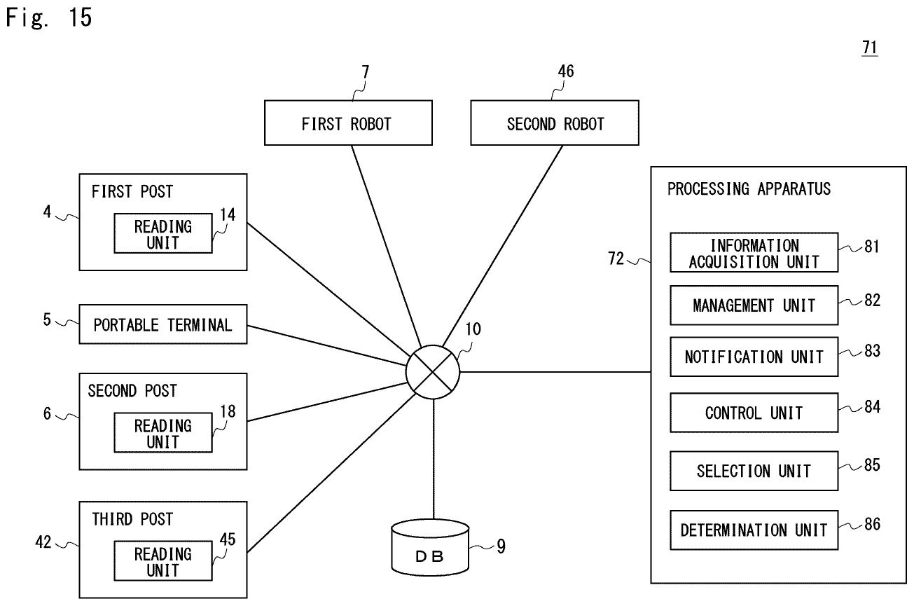

FIG. 15 is a block diagram showing a configuration of a control system of a storage system according to this embodiment. A storage system 71 according to this embodiment has a configuration roughly identical to that of the storage system 41 according to the second embodiment, and therefore, its detailed description is omitted. In this embodiment, an article G is stored in the second post 6 or the third post 42 based on the name of the article G.

In particular, as shown in FIG. 15, a processing apparatus 72 according to this embodiment has a configuration roughly identical to that of the processing apparatus 47 according to the second embodiment, and includes, in addition to an information acquisition unit 81, a management unit 82, a notification unit 83, a control unit 84, and a selection unit 85, a determination unit 86.

The determination unit 86 determines, for example, whether or not an article G is a seasonal article based on the name of the article G included in the article information of the article G. Then, when the article G is a seasonal article, the determination unit 86 preferably sets the possibility of retrieval of the article G in such a manner that the more the season in which the article G is used approaches, the higher value the possibility of retrieval of the article G is set to.

In this process, the determination unit 86 preferably periodically determines the possibility of retrieval of the article G. In this way, for example, the determination unit 86 determines the possibility of retrieval of the article G to be the lowest when the season in which the article G is used ends, and determines the possibility in such a manner that the more the aforementioned season approaches, the higher the possibility becomes.

The selection unit 85 selects which of the second post 6 and the third post 42 the article G should be stored in based on the possibility of retrieval of the article G. For example, the selection unit 85 selects the post in such a manner that the lower the possibility of retrieval of the article G is, a post further from the first post 4 is selected.

Further, the selection unit 85 selects the post in such a manner that the higher the possibility of retrieval of the article G is, a post closer to the first post 4 is selected. That is, the article G is moved to a post closer to the first post 4 as the season approaches. In this way, when the season in which the article G is used approaches and retrieval command information is received from the owner P, the article G can be swiftly delivered to the owner P.

In addition, since an article G which is unlikely to be used is stored in a post far from the first post 4, the occupancy ratio of posts near the first post 4 can be reduced, and the storage space of the first post 4 can be smoothly adjusted (i.e., organized).

Note that in this embodiment, the selection unit 85 selects a post in which an article G is stored based on the name of the article G. However, a season or the like in which the article G is likely to be used may be derived based on the relationship between the number of times the retrieval command information of the article G is received from the owner P and the date and time, and the post in which an article G is stored may be selected based on the derived season or the like as described above.

### Fourth Embodiment

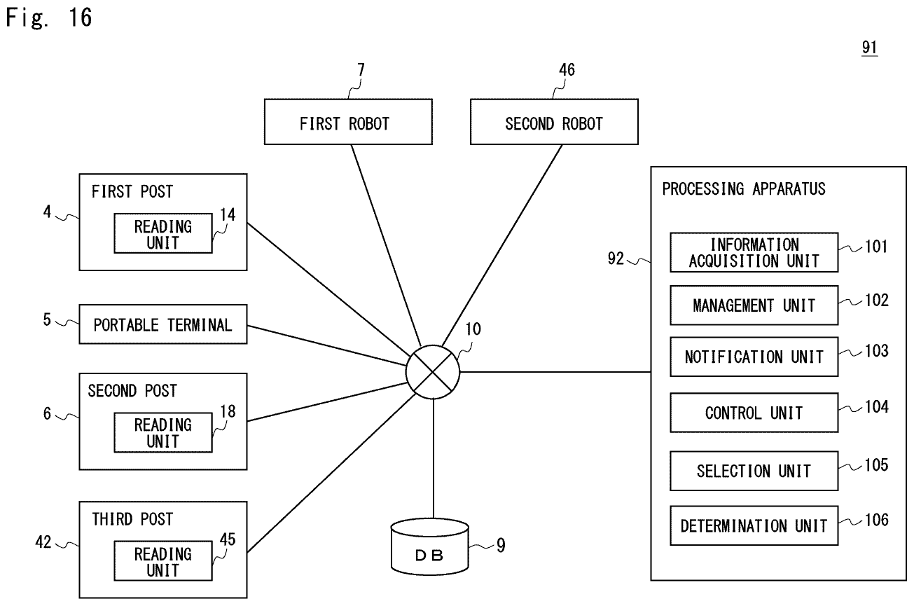

FIG. 16 is a block diagram showing a configuration of a control system of a storage system according to this embodiment. A storage system 91 according to this embodiment has a configuration roughly identical to that of the storage system 71 according to the third embodiment, and therefore, its detailed description is omitted. In this embodiment, a retrieval reminder or a deposit reminder is issued to the owner P of an article G based on the possibility of retrieval of the article G and the possibility of deposit of the article G.

In particular, as shown in FIG. 16, a processing apparatus 92 according to this embodiment has a configuration roughly identical to that of the processing apparatus 72 according to the third embodiment, and includes an information acquisition unit 101, a management unit 102, a notification unit 103, a control unit 104, a selection unit 105, and a determination unit 106.

In addition to the possibility of retrieval of the article G, the determination unit 106 determines the possibility of deposit of the article G. The determination unit 106 determines, for example, whether or not an article G is a seasonal article based on the name of the article G included in the article information of the article G. Then, when the article G is not a seasonal article, the determination unit 106 preferably sets the possibility of deposit of the article G in such a manner that the more the season in which the article G is used is distant, the higher value the possibility of deposit of the article G is set to.

For example, when the possibility of retrieval of the article G becomes equal to or higher than a predetermined threshold, the notification unit 103 sends a retrieval reminder to the portable terminal 5 of the owner P of the article G. Note that, for example, when periodic retrieval time information is included in the retrieval command information of the article G, the notification unit 103 preferably sends the reminder to the owner P immediately before the retrieval time.

Further, when the possibility of deposit of the article G becomes equal to or higher than a predetermined threshold, the notification unit 103 sends a deposit reminder to the portable terminal 5 of the owner P of the article G. Note that, for example, when periodic deposit time information is included in the deposit command information of the article G, the notification unit 103 preferably sends the reminder to the owner P immediately before the deposit time.

In this way, the usefulness of the system or the like for the owner P of the article G can be improved. Note that the date and time when an article G is likely to be retrieved may be derived based on the relationship between the number of times the retrieval command information of the article G is received from the owner P and the date and time, and a retrieval reminder may be sent to the portable terminal 5 of the owner P of the article G when the derived date and time approaches.

Similarly, the date and time when an article G is likely to be deposited may be derived based on the relationship between the number of times the deposit command information of the article G is received from the owner P and the date and time, and a deposit reminder may be sent to the portable terminal 5 of the owner P of the article G when the derived date and time approaches.

### Other Embodiments

Although the present disclosure has been described as a hardware configuration in the above-described first to fourth embodiments, the present disclosure is not limited to the above-described hardware configuration. In the present disclosure, the process performed by each component may be carried out by having a CPU (Central Processing Unit) execute a computer program.

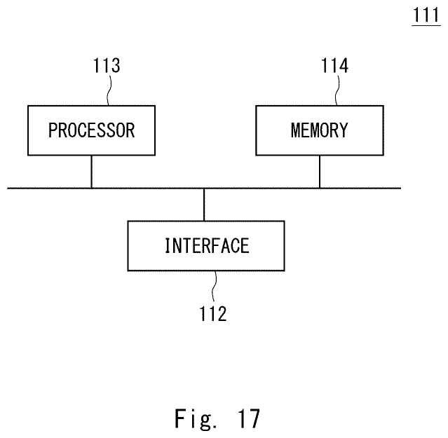

For example, each of the processing apparatuses 8, 47, 72 and 92 according to the above-described embodiments may have a hardware configuration described below. FIG. 17 shows an example of a hardware configuration included in each of the processing apparatuses 8, 47, 72 and 92.

The apparatus 111 shown in FIG. 17 includes an interface 112, a processor 113, and a memory 114. Each of the processing apparatuses 8, 47, 72 and 92 described in the above-described embodiments is implemented by having the processor 113 load and execute a program stored in the memory 114. That is, this program is a program for causing the processor 113 to function as the each of the processing apparatuses 8, 47, 72 and 92.

The above-described program includes instructions (or software codes) that, when loaded into a computer, cause the computer to perform one or more of the functions. The program may be stored in a non-transitory computer readable medium or a tangible storage medium. By way of example, and not a limitation, the non-transitory computer readable media or tangible storage media can include a RAM (Random-Access Memory), a ROM (Read-Only Memory), a flash memory, an SSD (Solid-State Drive) or other types of memory technologies, a CD-ROM, a DVD (Digital Versatile Disc), a Blu-ray (Registered Trademark) disc or other types of optical disc storage, and magnetic cassettes, magnetic tape, magnetic disk storage or other types of magnetic storage devices. The program may be transmitted on a transitory computer readable medium or a communication medium. By way of example, and not a limitation, the transitory computer readable media or communication media can include electrical, optical, acoustical, or other forms of propagation signals.

Although the present disclosure is described above with reference to example embodiments, the present disclosure is not limited to the above-described example embodiments. Various modifications that can be understood by those skilled in the art can be made to the configuration and details of the present disclosure within the scope and spirit of the disclosure. Further, the example embodiments may be combined with one another as appropriate.

For example, although the determination unit of the processing apparatus may select the second post 6 or the third post 42 as the deposit post for the article G based on the possibility of retrieval of the article G, the determination unit may select a post far from the first post 4 as the deposit post based on information about the height of the article G.

For example, the larger the height of the article G is, a post farther from the first post 4 is selected as the deposit post. In this way, an article G having a large height can be deposited in a post which is installed at a place far from the housing complex and of which the land price is low. In this way, the storage space of the first post 4 can be adjusted (i.e., organized) at a low cost.

For example, an article G stored in the second post 6 may be moved to a third post 42 near this second post 6, and by doing so, the storage space of the second post 6 may be temporarily increased.

For example, when a predetermined time period has elapsed in a state where an article G stored in the first post 4, the second post 6, or the third post 42, the management unit of the processing apparatus may inquire, through the notification unit, of the owner P about the permission to dispose of the article G or move the article G to a post far from the first post 4.

For example, the retrieval command information of the article G may include reservation information for reserving the retrieval time of the article G, and/or the deposit information of the article G may include reservation information for reserving the deposit time of the article G. Then, the processing apparatus may retrieve the article G or deposit the article G based on these reservation information items.

For example, the information acquisition unit of the processing apparatus may acquire vacant individual dwelling information of the housing complex and use, when it deposits the article G in the second post 6, the post of the vacant individual dwelling as the second post 6.

For example, the first post 4 may be used as a delivery box. In this case, a predetermined area of the first post 4 may be used as a delivery box, and an article G may be stored in the other area of the first post 4. Further, the structure of the first post 4 is merely an example. That is, it is sufficient if at least an article G can be stored in the first post 4.

For example, the structures of the second post 6 and the third post 42 are also merely examples. That is, it is sufficient if at least an article G can be stored in each of them.

For example, although an article G is conveyed between the second post 6 and the third post 42 by the second robot 46 in the above-described embodiments, the article G may be conveyed by a worker. In this case, instruction information for conveying the article G may be transmitted to a portable terminal or the like processed by the worker.

For example, although an article G is conveyed by the tray 2 in the state where the article G is stored in the storage box 3 in the above-described embodiments, it is sufficient if at least the article G is conveyed. Further, the structure of the robot is merely an example, and it is sufficient if the robot can retrieve an article G from a post, convey the article G, and store the article G in another post.

For example, although the owner P inputs deposit command information, retrieval command information, and the like through the portable terminal 5 in the above-described embodiments, such information items may be input through an input device or the like disposed in the vicinity of the first post 4.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A processing apparatus used to convey, by a first robot configured to move inside a housing complex, an article between first posts installed in the housing complex and assigned to respective individual dwellings of the housing complex and a second post installed in the housing complex and shared by the individual dwellings of the housing complex, comprising:
an information acquisition unit configured to acquire deposit command information for depositing an article stored in the first post in the second post and retrieval command information for retrieving the article from the second post and storing the retrieved article in the first post; and
a control unit configured to control the first robot based on the deposit command information or the retrieval command information.

2. The processing apparatus according to claim 1, wherein the control unit controls a second robot configured to move outside the housing complex or notifies a worker so that the article stored in the second post is stored in a third post installed outside the housing complex.

3. The processing apparatus according to claim 2, further comprising a selection unit configured to select which of the second post and the third post the article should be deposited in, wherein
the information acquisition unit acquires desired time limit information until the article retrieved from the second post or the third post is stored in the first post, and
the selection unit selects which of the second post and the third post the article should be deposited in based on the desired time limit information.

4. The processing apparatus according to claim 3, wherein
a plurality of third posts are arranged, and
the selection unit selects the third post in such a manner that the longer the desired time limit information is, a third post further from the first post is selected.

5. The processing apparatus according to claim 2, wherein
the information acquisition unit acquires the retrieval command information of the article or article information including a name of the article, and
the processing apparatus comprises:
a determination unit configured to determine a possibility of retrieval of the article based on the retrieval command information of the article or the article information, and
a selection unit configured to select which of the second post and the third post the article should be deposited in based on the possibility of retrieval of the article.

6. The processing apparatus according to claim 5, wherein
a plurality of third posts are arranged, and
the selection unit selects the third post in such a manner that the lower the possibility of retrieval of the article is, a third post further from the first post is selected.

7. The processing apparatus according to claim 6, wherein
the determination unit periodically determines the possibility of retrieval of the article, and
the selection unit periodically selects the third post in such a manner that the higher the possibility of retrieval of the article is, a third post closer to the first post is selected.

8. The processing apparatus according to claim 1, wherein
the information acquisition unit acquires the retrieval command information of the article or article information including a name of the article, and
the processing apparatus comprises:
a determination unit configured to determine a possibility of retrieval of the article based on the retrieval command information of the article or the article information, and
a notification unit configured to send a retrieval reminder to an owner of the article based on the possibility of retrieval of the article.

9. The processing apparatus according to claim 8, wherein the retrieval command information includes periodic retrieval time information of the article.

10. The processing apparatus according to claim 8, wherein
the information acquisition unit acquires the deposit command information of the article or article information including a name of the article,
the determination unit determines a possibility of deposit of the article based on the deposit command information of the article or the article information, and
the notification unit sends a deposit reminder to an owner of the article based on the possibility of deposit of the article.

11. The processing apparatus according to claim 10, wherein the deposit command information includes periodic deposit time information of the article.

12. A storage system comprising:
a processing apparatus according to claim 1;
first posts installed in the housing complex and assigned to respective individual dwellings of the housing complex;
a second post installed in the housing complex and shared by the individual dwellings of the housing complex; and
a robot configured to move inside the housing complex and convey an article between the first post and the second post.

13. A processing method used to convey, by a robot configured to move inside a housing complex, an article between first posts installed in the housing complex and assigned to respective individual dwellings of the housing complex and a second post installed in the housing complex and shared by the individual dwellings of the housing complex, wherein
a computer performs:
acquiring deposit command information for depositing an article stored in the first post in the second post and retrieval command information for retrieving the article from the second post and storing the retrieved article in the first post; and
controlling the robot based on the deposit command information or the retrieval command information.

14. A non-transitory computer readable storage medium storing a processing program used to convey, by a robot configured to move inside a housing complex, an article between first posts installed in the housing complex and assigned to respective individual dwellings of the housing complex and a second post installed in the housing complex and shared by the individual dwellings of the housing complex, wherein the processing program causes a computer to perform:
a process of acquiring deposit command information for depositing an article stored in the first post in the second post and retrieval command information for retrieving the article from the second post and storing the retrieved article in the first post; and
a process of controlling the robot based on the deposit command information or the retrieval command information.
